(19) United States
(12) Patent Application Publication
(10) Pub. No.: US 2006/0268870 A1
(43) Pub. Date: Nov. 30, 2006

(54) AUTOMATIC ADDRESSING METHOD

(76) Inventors: Yu-Tang Shen, Tainan (TW); Robert Chen, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/279,307

(22) Filed: Apr. 11, 2006

(30) Foreign Application Priority Data
May 12, 2005 (TW) 094115353

(51) Int. Cl. H04L 12/56

(52) U.S. Cl. 370/390

(57) ABSTRACT

An automatic addressing method, which is applied to communicate a plurality of repeaters in the same area so as to set the respective delayed time, comprising steps describes as follows: (a) The controlling unit of the repeater is inquired whether any other repeaters exist and the numbers of the already existed repeaters through the transmitting unit; (b) The receiving unit of the repeater receives the information so as to know the numbers of the already existed repeaters; (c) The controlling unit of the repeater selects a number that not repeat to that of other repeaters, and sends out the information through the transmitting unit so as to inform other repeaters its adopted number; (d) During a time interval, if the repeater didn't receive the opposing information of other repeaters, then skipped to step (e), if receives any opposing information, it will skip to step (c); (e) The controlling unit stores the number to its memory unit, and later transmits the signals that sent out from the receiving end according to the indicated delayed time of the number.

### BACKGROUND OF THE INVENTION

1. Field of the Invention

The present invention relates to an automatic addressing method, and more particularly to an automatic addressing method and the signal transmitting system of using this method.

2. Description of the Prior Art

A conventional emitting end sent out signals to a receiving end, a repeater is usually added to avoid dead space or weak signals because of long distance, so that the signals sent out from the emitting end will be amplified by the repeater firstly, and then transmitted to the receiving end so as to receive better signals.

However, if there are several repeaters in the same area simultaneously, the signals sent out from the emitting end will be amplified by the identical repeaters firstly, and then transmitted to the receiving end respectively. At that time, the receiving end will be received multi-signals transmitted by the identical repeaters in a short time, thereby the receiving end will be driven falsely.

For example, if a first repeater and a second repeater are existed in an area, the receiving end is an electronic switch, and the characteristic of the electronic switch is that the switch will be changed from opening to closing, or changed from closing to opening when triggered by the signals.

If the emitting end sent out a signal for changing the switch from closing to opening, the first repeater and the second repeater are all received the signal sent out from the emitting end, and transmitted to the electronic switch respectively. If the electronic switch received the signal transmitted by the first repeater firstly, the electronic switch can be opened successfully, however, the signal transmitted by the second repeater will be triggered the electronic switch again, thus closing the electronic switch. Therefore, when multi-repeaters are existed in one area, the receiving end will be triggered constantly because of the influences of the signals transmitted by multi-repeaters.

In addition, since the working frequency of the first repeater is similar to that of the second repeater in the same area, and amplified the signals that sent out from the sending end at once, and then transmitted, however, the signals that sent out simultaneously are usually cross-talked each other, result in the wrong signals received by the receiving end. Therefore, between the repeaters of the same area should be a suitable communication agreement, so that the times of sending out signals after being received signals of each repeater are different.

The present invention has arisen to mitigate and/or obviate the afore-described disadvantages.

### SUMMARY OF THE INVENTION

The primary objective of the present invention is to provide a signal transmitting system which can produce better signals.

The further objective of the present invention is to provide a receiver that will not be triggered constantly, and to provide a repeater that will not be cross-talked each other when transmitting signals, and to provide an automatic addressing method.

The signal transmitting system of the present invention comprises an emitter for emitting signals, a plurality of repeaters and receivers. The identical repeaters will be communicated each other so as to set the respective delayed transmitting time, and received the signals sent out from the emitter and amplified, and then transmitted the amplified signals to the identical receivers according to the respective delayed transmitting time. The identical receivers can receive the signals transmitted by the identical repeaters, however, when the receiver receives a signal, the next signal will be received after a time interval.

The receiver of the present invention is applied to receive the signal transmitted by the emitter, which comprises the above-mentioned a plurality of repeaters and receivers.

The above-mentioned repeater includes a receiving unit, a transmitting unit, a memory unit and a controlling unit. The receiving unit is able to receive the signals sent out from a transmitting end and the information transmitted by a repeater in the same area. The transmitting unit can send out the signals to a receiving end and transmit the information to the repeater in the same area. The memory unit is provided for storing the number represent the delayed time of the repeater.

The controlling unit is electrically connected to the receiving unit, the transmitting unit and the memory unit, and amplified the signals sent out from the receiving unit firstly, and then transmitted the amplified signals to the receiving end through the transmitting unit after the delayed time, and the controlling unit can set the numbers of the memory unit according to the information transmitted by the repeaters in the same area, so that the numbers of the memory unit will not be repeated with that of other repeaters.

The automatic addressing method of the present invention comprises the steps describes as follows:

(a) The controlling unit of the newly added repeater sends out the information through the transmitting unit, and the content of the information is inquired whether any other repeaters exist and the numbers of the already existed repeaters.

(b) The receiving unit of the newly added repeater receives the information that sent out by other repeaters so as to know the numbers of the already existed repeaters.

(c) The controlling unit of the newly added repeater selects a number that not repeat to that of other repeaters, and sends out the information through the transmitting unit so as to inform other repeaters its adopted number.

(d) During a time interval, if the newly added repeater didn't receive the opposing information of other repeaters, then skipped to step (e), if receives any opposing information of other repeaters, it will skip to step (c).

(e) The controlling unit stores the number to its memory unit, and later transmits the signals that sent out from the receiver according to the indicated delayed time of the number.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of an automatic addressing method in accordance with a preferred embodiment of the present invention;

FIG. 2 is a block diagram view of the preferred embodiment in accordance with the present invention;

FIG. 3 is a processing view of the preferred embodiment in accordance with the present invention;

FIG. 4 is a view of showing the information indicated by the functional bits of the preferred embodiment.

### DETAILED DESCRIPTION OF THE PREFERRED EMBODIMENTS

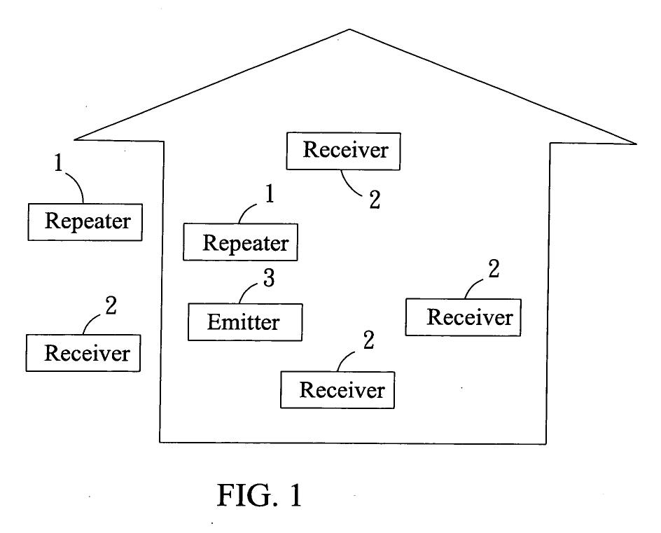

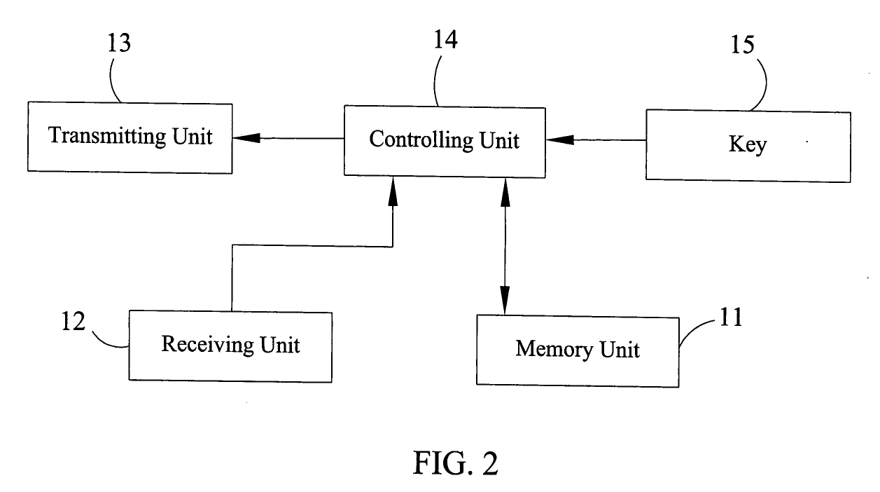

Referring to FIGS. 1 and 2, an automatic addressing method in accordance with the present invention comprises a plurality of repeaters 1, a plurality of receivers 2 and an emitter 3. The signals that sent out by the emitter 3 are amplified by the repeaters 1, and then received by the receivers 2. The emitter 3 can be a remote controlling device with no battery, the receiver 2 can be an electronic switch, and each electronic switch has a socket for the using of electronic products, however, it is to be noted that the emitter 3 and the receiver 2 are not limited to the above said.

When the receiver 2 receives a signal, the next signal will be received after a time interval, and the time interval is according to the requirement, for example, two seconds, in order to prevent the receiver 2 from triggering constantly by the transmitted signals of different repeaters 1. In the present embodiment, similarly, when the repeater 1 receives a signal, the next signal will be sent out after a time interval.

Each repeater 1 includes a memory unit 11, a receiving unit 12, a transmitting unit 13, a controlling unit 14 and a key 15.

The receiving unit 12 of each repeater 1 is provided for receiving the signals sent out by the emitter 3 and the information transmitted by other repeaters 1, and then sending out those signals and information to the controlling unit 14. The transmitting unit 13 is controlled by the controlling unit 14, thus sending out the signals and information to the receiver 2 or other repeaters 1.

The memory unit 11 stores a number that indicates the time interval of sending out the signals to the receiver 2 after the signals that sent out by the emitter 3 being processed by the controlling unit 14. For example, if the number stored by the memory unit 11 of one repeater 1 is 1, which indicating that the signals will be sent out to the receiver 2 after 100 msec when processed by the controlling unit 14; and similarly, if the numbers stored by the repeaters 1 are 2 and 5, which indicating that the signals will be sent out to the receiver 2 after 100 and 500 msec respectively when processed by the controlling unit 14.

It is to be noted that the relative relationship of the number and the delayed transmitting time is not limited to the above said, as long as the indicated delayed times of each number are different, and the identical delayed times can separate the signals sent out by each repeater 1 efficiently. Therefore, the delayed times of the number 1 and 2 of the repeaters 1 can be 150 and 300 msec respectively, and the setting rule is adjusted by the controlling unit 14.

What is more important is that the memory unit 11 of the identical repeater 1 can be stored repeated numbers, so that an automatic addressing mechanism must be provided between the identical repeaters 1 for precise setting the respective number automatically. Therefore, a new repeater 1 is added to the area of the identical repeater 1, and user only needed to press a key 15 of the new repeater 1 that the key 15 will be produce a reset signal and transmitted to the controlling unit 14, and the automatic addressing mechanism will be opened by the controlling unit 14. How to set the addressing mechanism of the numbers will be described in detail later.

After the signals that sent out by the emitter 3 are received by the receiving unit 12 of the repeater 1, firstly the controlling unit 14 will be amplified the signals, and then decided the time interval according to the stored number of the memory unit 11, and sent out the processed signals to the receiver 2 through the transmitting unit 13.

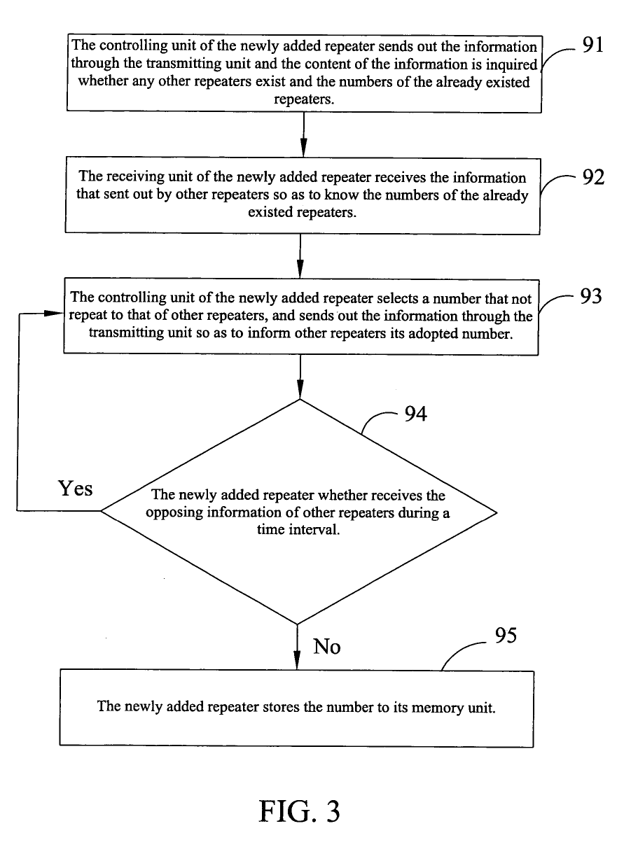

Referring to FIG. 3, the automatic addressing method of the repeater 1 comprises the following steps:

With regard to step 91, the controlling unit 14 of the newly added repeater 1 sends out the information through the transmitting unit 13, and the content of the information is inquired whether any other repeaters 1 exist and the numbers of the already existed repeaters 1.

With regard to step 92, the receiving unit 12 of the newly added repeater 1 receives the information that sent out by other repeaters 1 so as to know the numbers of the already existed repeaters 1.

With regard to step 93, the controlling unit 14 of the newly added repeater 1 selects a number that not repeat to that of other repeaters 1, and sends out the information through the transmitting unit 13 so as to inform other repeaters 1 its adopted number.

With regard to step 94, during a time interval, if the newly added repeater 1 didn't receive the opposing information of other repeaters 1, then skipped to step 95, if receives any opposing information of other repeaters 1, it will skip to step 93.

With regard to step 95, the newly added repeater 1 stores the number to its memory unit 11, and later transmits the signals that sent out from the receiver 2 according to the indicated delayed time of the number.

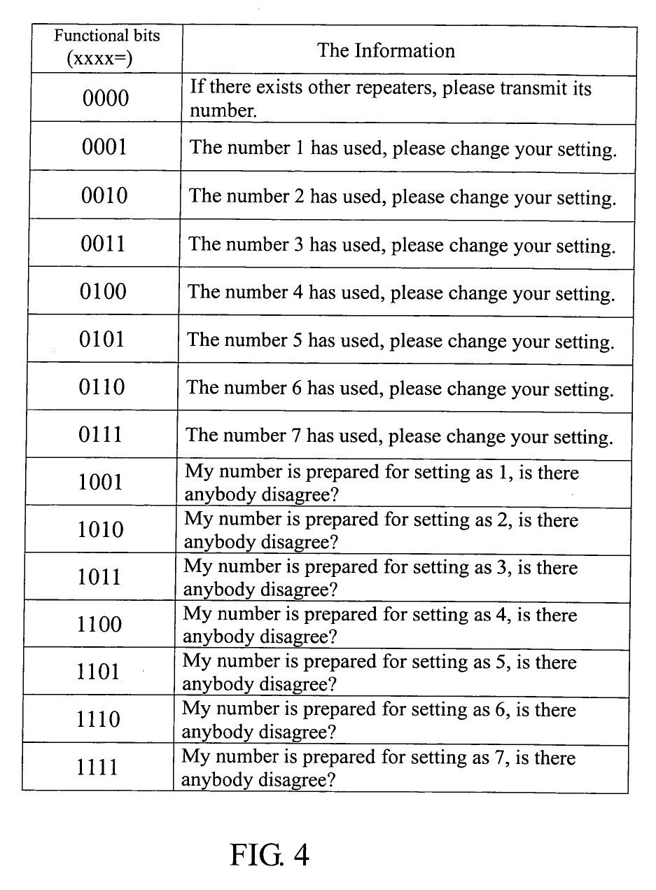

Now take a simple instance, if there are already six repeaters 1 in an area: the first repeater 1, the second repeater 1, the third repeater 1 to the sixth repeater 1, and the stored numbers of those six repeaters 1 are 1 to 6 respectively. If added a seventh repeater 1, each information of its communication agreement will contain 32 bits, and the last 4 bits are functional bits, the former 28 bits are set to 0 when the repeater 1 is addressing, and the value indicated by the functional bits as shown in FIG. 4, when the functional bit is 0000, which shows that if there exists other repeaters, please transmitted its number. And when the functional bit is 0001, which shows that the number 1 has used, please change your setting, and the information indicated by other functional bits as shown in FIG. 4.

When pressing the key 15 of the seventh repeater 1, the process of addressing of the seventh repeater 1 describes as follows:

According to the step 91, the transmitting unit 13 of the seventh repeater 1 will be transmitted the information of the functional bit 0000 to the outside.

Suppose that now the first to the fifth repeaters 1 are all worked normally, and the sixth repeater 1 cannot worked normally because of receiving other signals, thereby according to the step 92, the seventh repeater 1 will be received the information of functional bits 0001, 0010, 0011, 0100 and 0101, however, it cannot be received the information of functional bit 0110 that sent out from the sixth repeater 1.

According to the step 93, since the controlling unit 14 of the seventh repeater 1 judged that the unusable numbers are 1 to 5 based on the received information, supposed that the number of the seventh repeater 1 is 6, the information of 1110 will be sent out to other repeaters 1 through its emitting unit 13.

According to the step 94, since the sixth repeater 1 has been worked normally, it will send out the information of 0110 to the seventh repeater 1 so as to inform the seventh repeater 1 that number 6 has been used, and then skipped to the step 93.

According to the step 93, the seventh repeater 1 chose number 7 and sent out the information of 1111 to the outside.

According to the step 94, since the seventh repeater 1 didn't receive any other opposing information during a predetermined time, and then skipped to the step 95.

According to the step 95, the controlling unit 14 of the seventh repeater 1 stored number 7 to its memory unit 11, and later sent out the information to the receiver 2 based on the indicated delayed time of number 7.

It is to be noted that the corresponding relation of the functional bits and the indicated information are not limited to the above, and the numbers of the functional bits can be changed according to the increased number of the repeaters 1 of the same area.

To sum up, since the repeater 1 of the present invention has the function of addressing automatically, the delayed time of each repeater 1 can be adjusted, and the repeaters 1 will not be disturbed each other. Furthermore, when the receiver 2 of the present invention receives a signal, the next signal will be received after a time interval, thus solving the conventional problem of triggering constantly.

While we have shown and described various embodiments in accordance with the present invention, it should be clear to those skilled in the art that further embodiments may be made without departing from the scope of the present invention.

What is claimed is:

1. A signal transmitting system, comprising:
an emitter, which is provided for transmitting signals;
a plurality of repeaters, which are communicated each other so as to set the respective delayed transmitting time, and received the signals sent out from the emitter and amplified, and then transmitted the amplified signals to the identical receivers according to the respective delayed transmitting time; and
a plurality of receivers, which can receive the signals transmitted by the identical repeaters, however, when the receiver receives a signal, the next signal will be received after a time interval.

2. The signal transmitting system as claimed in claim 1, wherein the identical repeaters are communicated by transmitting information each other, and each information includes multi-functional bits, and different values of the functional bits are indicative of different information.

3. The signal transmitting system as claimed in claim 1, wherein when the repeater transmits a signal, the next signal is transmitted after a time interval.

4. The signal transmitting system as claimed in claim 1, wherein each repeater comprises:
a receiving unit, which is able to receive the signals sent out from the emitter and the information transmitted by other repeaters;
a transmitting unit, which is able to send out the signals to the receiver and transmit the information to other repeaters;
a memory unit, which is provided for storing the number represent the delayed time of the repeater; and
a controlling unit, which is electrically connected to the receiving unit, the transmitting unit and the memory unit, and amplified the signals sent out from the receiving unit firstly, and then transmitted the amplified signals to the receiver through the transmitting unit after the delayed time, and the controlling unit can set the numbers of the memory unit according to the information transmitted by other repeaters, so that the numbers of the memory unit are not be repeated with that of other repeaters.

5. The signal transmitting system as claimed in claim 4, wherein each repeater is further included a key, and when pressing the key, the controlling unit is worked so as to reset the numbers.

6. The signal transmitting system as claimed in claim 4, wherein the controlling unit is able to set the delayed time indicated by the numbers, and the delayed time is provided for separating all the signals transmitted by the identical repeaters.

7. A receiver, which is provided for receiving the signals transmitted by a repeater, which comprises:
a plurality of repeaters, which are communicated each other so as to set the respective delayed transmitting time, and received the signals sent out from the emitter and amplified, and then transmitted the amplified signals to the identical receivers according to the respective delayed transmitting time; and
a plurality of receivers, which can receive the signals transmitted by the identical repeaters, however, when the receiver receives a signal, the next signal will be received after a time interval.

8. The receiver as claimed in claim 7, wherein the identical repeaters are communicated by transmitting the information each other, and each information includes multi-functional bits, and different values of the functional bits are indicative of different information.

9. The receiver as claimed in claim 7, wherein when the repeater transmits a signal, the next signal is transmitted after a time interval.

10. The receiver as claimed in claim 7, wherein each repeater comprises:
a receiving unit, which is able to receive the signals sent out from the emitter and the information transmitted by other repeaters;
a transmitting unit, which is able to send out the signals to the receiver and transmit the information to other repeaters;
a memory unit, which is provided for storing the number represent the delayed time of the repeater; and
a controlling unit, which is electrically connected to the receiving unit, the transmitting unit and the memory unit, and amplified the signals sent out from the receiving unit firstly, and then transmitted the amplified signals to the receiver through the transmitting unit after the delayed time, and the controlling unit can set the numbers of the memory unit according to the information transmitted by other repeaters, so that the numbers of the memory unit are not be repeated with that of other repeaters.

11. The receiver as claimed in claim 10, wherein each repeater is further included a key, and when pressing the key, the controlling unit is worked so as to reset the numbers.

12. The receiver as claimed in claim 10, wherein the controlling unit is able to set the delayed time indicated by the numbers, and the delayed time is provided for separating all the signals transmitted by the identical repeaters.

13. A repeater, comprising:
a receiving unit, which is able to receive the signals sent out from a transmitting end and the information transmitted by a repeater in the same area;
a transmitting unit, which is able to send out the signals to a receiving end and transmit the information to the repeater in the same area;
a memory unit, which is provided for storing the number represent the delayed time of the repeater; and
a controlling unit, which is electrically connected to the receiving unit, the transmitting unit and the memory unit, and amplified the signals sent out from the receiving unit firstly, and then transmitted the amplified signals to the receiving end through the transmitting unit after the delayed time, and the controlling unit can set the numbers of the memory unit according to the information transmitted by the repeaters in the same area, so that the numbers of the memory unit are not be repeated with that of other repeaters.

14. The repeater as claimed in claim 13, wherein each information includes multi-functional bits, and different values of the functional bits are indicative of different information.

15. The repeater as claimed in claim 13, wherein when the transmitting unit transmits a signal, the next signal is transmitted after a time interval.

16. The repeater as claimed in claim 13, wherein each repeater is further included a key, and when pressing the key, the controlling unit is worked so as to reset the numbers.

17. The repeater as claimed in claim 13, wherein the controlling unit is able to set the delayed time indicated by the numbers, and the delayed time is provided for separating the signals transmitted by each repeater in the same area.

18. An automatic addressing method, which is applied to communicate a plurality of repeaters in the same area so as to set the respective delayed time, and each repeater includes a receiving unit, a transmitting unit, a memory unit and a controlling unit, which comprises steps describes as follows: (a) The controlling unit of the newly added repeater sends out the information through the transmitting unit, and the content of the information is inquired whether any other repeaters exist and the numbers of the already existed repeaters; (b) The receiving unit of the newly added repeater receives the information that sent out by other repeaters so as to know the numbers of the already existed repeaters; (c) The controlling unit of the newly added repeater selects a number that not repeat to that of other repeaters, and sends out the information through the transmitting unit so as to inform other repeaters its adopted number; (d) During a time interval, if the newly added repeater didn't receive the opposing information of other repeaters, then skipped to step (e), if receives any opposing information of other repeaters, then skipped to step (c); (e) The controlling unit stores the number to its memory unit, and later transmits the signals that sent out from the receiver according to the indicated delayed time of the number.

19. The automatic addressing method as claimed in claim 18, wherein each repeater is further included a key, and when pressing the key, the controlling unit is worked so as to reset the numbers.

20. The automatic addressing method as claimed in claim 18, wherein each information includes multi-functional bits, and different values of the functional bits are indicative of different information.

21. The automatic addressing method as claimed in claim 18, wherein 4 bits of each information is functional bits, when the functional bit is 0000, which shows that if there exists other repeaters, please transmit its number; when the functional bit is 0001, which shows that the number 1 has used, please change your setting; when the functional bit is 0010, which shows that the number 2 has used, please change your setting; when the functional bit is 0011, which shows that the number 3 has used, please change your setting; when the functional bit is 0100, which shows that the number 4 has used, please change your setting; when the functional bit is 0101, which shows that the number 5 has used, please change your setting; when the functional bit is 0110, which shows that the number 6 has used, please change your setting; when the functional bit is 0111, which shows that the number 7 has used, please change your setting; when the functional bit is 1001, which shows that my number is prepared for setting as 1, is there anybody disagree; when the functional bit is 1010, which shows that my number is prepared for setting as 2, is there anybody disagree; when the functional bit is 1011, which shows that my number is prepared for setting as 3, is there anybody disagree; when the functional bit is 1100, which shows that my number is prepared for setting as 4, is there anybody disagree; when the functional bit is 1101, which shows that my number is prepared for setting as 5, is there anybody disagree; when the functional bit is 1110, which shows that my number is prepared for setting as 6, is there anybody disagree; and when the functional bit is 1111, which shows that my number is prepared for setting as 7, is there anybody disagree.
